(19) United States
(12) Patent Application Publication
(10) Pub. No.: US 2015/0277748 A1
(43) Pub. Date: Oct. 1, 2015

(54) EDIT PROVIDING METHOD ACCORDING TO MULTI-TOUCH-BASED TEXT BLOCK SETTING

(71) Applicant: Geun-Ho Shin, Suwon-si Gyeonggi-do (KR)

(72) Inventor: Geun-Ho Shin, Suwon-si Gyeonggi-do (KR)

(21) Appl. No.: 14/437,384

(22) PCT Filed: Aug. 31, 2013
(86) PCT No.: PCT/KR2013/007856

§ 371 Date: Apr. 21, 2015

(30) Foreign Application Priority Data
Oct. 22, 2012 (KR) 10-2012-0117047
Apr. 10, 2013 (KR) 10-2013-0038906

(51) Int. Cl. G06F 3/0488; G06F 3/0482; G06F 3/041

(52) U.S. Cl. CPC G06F 3/04883; G06F 3/041; G06F 3/04886; G06F 3/0482

(57) ABSTRACT

The present invention relates to a technique for setting a text block based on a multi-touch manipulation performed by a user on a virtual keyboard of a touch device, such as a touch screen or a track pad, on a smart phone or a smart pad and performing various edit operations (copy, cut, paste, or block movement, etc.). According to the present invention, edit time is shortened and user convenience is provided when a user sets a text block and simplifies an edit process using multi-touches. In particular, when the present invention is applied to a virtual keyboard user environment, a text block can be set in a text sentence and various edit functions can be performed through a manipulation in the same style as a text input. Accordingly, document editing can be easily performed even in a smart phone having a small display.

### TECHNICAL FIELD

The present disclosure relates to a technology for editing operations according to a multi-touch based text block selection suitable for application in such devices as smart phones and smart pads. More particularly, the present disclosure relates to providing editing operations according to a multi-touch-based text block selection on various applications based on user's multi-touch operations on the virtual keyboard of the touch device such as the operations on a touch screen or a track pad so as to carry out various editing functions including copying, cutting, pasting and moving the block.

### BACKGROUND

Growing functional complications and diversifications of smart phones, MP3 players, PMP (portable multimedia player), PDA (personal digital assistant) and smart pads have added to the multifunctionality of these mobile devices. The mobile devices have become more frequent platforms for making various notes, managing schedule, entering text messages or e-mailing and searching for information over the Internet.

As a means for entering textual data, existing mobile devices started to have mechanical buttons. However, mechanical limitations of small mobile devices necessitated assigning two to three letters (grouped by e.g., consonants and vowels) per button of proportionally reduced size which passed the inputting hassle to users.

This is addressed by the advent of smart phones (e.g., iPhone) or a smart pad (e.g., iPads) with a virtual keyboard displayed on the wide screen for user to type inputs. The Android platform introduced will continue to generalize character inputs through touch screens. Further, trackpad-based devices are actively introduced in the market centered on Apple Accessory Protocol and will spread the touch-based data input technology.

Employing multi-touch technology is an ongoing trend for the mobile devices. The advantage of the multi-touch system is to provide the added convenience to the user for controlling the mobile device by using multiple fingers at the same time. However, in entering and correcting characters, the touch method is still inconvenient as compared to the personal computer environment. As a means for input operation, personal computer utilizes a keyboard dedicated to inputting characters and a mouse with left and right buttons for carrying out a text block selection and various editing functions (such as copy, cut, paste, clipboard). Optimized to such specifically designated functions, the keyboard and mouse serve well enough for the user's easy text input and editing purpose.

On the other hand, the touch device is a technique that emulates these input devices just to enable inputting characters to some extent, but it comes short of conveniently selecting text block and performing editing functions. Of the Android platform devices, Samsung Galaxy S2 is a smart phone configured so that a text block is first selected with the whole text sentence double-clicked or roughly selected in a pop-up menu followed by fine-tuning of the text block selection at the precise area. Thus, in the prior art, it has been cumbersome to set or select the text block and use the same to perform editing functions.

### RELATED PRIOR ART

1. Korean Patent Application No. 10-2010-0025169 (Portable Information Input Device)

2. Korean Patent Application No. 10-2009-0072076 (Mobile Communication Terminal and Method for Edit via Multi-Touch in Thereof)

### DISCLOSURE

### Technical Problem

The present disclosure seeks to provide a technology for editing operations according to a multi-touch based text block selection suitable for application in such devices as smart phones and smart pads. More particularly, the present disclosure is directed to implementing an editing technology according to a multi-touch-based text block selection, which simplifies selection and diverse editing operations of a block of text, resulting in a reduction of the editing time.

### SUMMARY

In accordance with some embodiments of the present disclosure, a method for providing an editing operation according to a multi-touch-based text block selection includes: in a touch device displaying a text sentence, performing, by a mode detection module (13a), a first identification of at least one multi-touch event on a virtual keyboard of the touch device and a second identification of an event of a touch move representing a movement concurrent with and from a touch at one or more touch points constituting the multi-touch event; if an identified touch move exceeds a preset threshold limit, performing, by a mode selection module (13b), an implementation of a block cursor represented by the opposite edges (21a, 21b) for defining a text block selected from a displayed text sentence, and an allocation of two of the touch points constituting the multi-touch event to two opposite edges of the block cursor; and responsive to each touch move (23a, 23b) of two allocated touch points, performing a fine tuning of a text block selection as defined by the block cursor (21a, 21b) by individually moving the opposite edges of the block cursor.

In accordance with some embodiments of the present disclosure, a method for providing an editing operation may further include detecting a touch remove event that the two touch points constituting the multi-touch event are both touch-removed within the preset threshold limit; processing an earlier touch-removed condition of a first touch point according to the order of touches in the multi-touch event, as a selection of a character key corresponding to the position of the first touch point in the virtual keyboard; and responsive to an earlier touch-removed condition of a second touch point according to the order of touches in the multi-touch event, implementing an editing use window which includes a function menu of a plurality of functions for an editing use of a preprocessed text block.

In accordance with some embodiments of the present disclosure, a method for providing an editing operation may further include responsive to a preset touch-based block selection completion event, implementing, by a first editing module (13c), a first editing toolbar window having one or more menu functions of a cut, move, paste and clipboard for providing an editing function upon completion of the text block selection; performing, by the first editing module (13c), the editing function with respect to the selected text block in response to a user's first selected input of one of a plurality of the menu functions on the first editing toolbar window; responsive to a touch manipulation on the touch device, moving an editing cursor to a desired position in a currently displayed text sentence; responsive to a preset editing use event, implementing, by a second editing module (13d), an editing use window including one or more menu functions of a paste and a clipboard for providing an editing use of a preprocessed text block; and performing, by the second editing module (13d), the editing use of the preprocessed text block in response to a user's second selected input of one of a plurality of the menu functions on the editing use window.

In accordance with some embodiments of the present disclosure, a method for providing an editing operation may further include responsive to a preset touch-based block movement start event, performing, by a block moving module (13e), a cut process at an original position of the selected text block, with respect to the selected text block when a touch point constituting the preset touch-based block movement start event starts to depart from a threshold limit, and repositioning the selected text block after the cut process in response to a subsequent touch move input.

In accordance with some embodiments of the present disclosure, a method for providing an editing operation may further include responsive to a preset touch-based block movement start event, performing, by a block moving module (13e), a cut process at an original position of the selected text block, with respect to the selected text block after repositioning thereof upon receiving a touch move input.

In accordance with some embodiments of the present disclosure, a method for providing an editing operation may further include upon completion of the fine tuning of the text block selection and responsive to a subsequent touch-removed condition of only one of touch points of the multi-touch event, selecting a movement menu function by default and implementing a second editing toolbar window having an arrangement of a plurality of menu functions; responsive to a touch-removed condition of the touch-maintained remainder of the touch points of the multi-touch event after moving past a threshold limit, and in response to the moving direction, selectively executing one of menu functions on the second editing toolbar window; responsive to a touch-removed condition of the touch-maintained remainder of the touch points of the multi-touch event within the threshold limit, implementing a first move display window for displaying a movement of the text block; and subsequent to a second touch, processing the text block to make a movement corresponding to a touch remove event after passing the threshold limit in response to the moving direction, and processing a touch-removed condition within the threshold limit as a selection of a character key at the corresponding position in the virtual keyboard.

In accordance with some embodiments of the present disclosure, a method for providing an editing operation may further include implementing a second move display window for displaying a movement of the text block upon completion of the fine tuning of the text block selection and responsive to a subsequent touch-removed condition of only one of touch points of the multi-touch event; processing the text block to make a movement corresponding to a touch remove event of touch-maintained ones of the touch points of the multi-touch event after passing the threshold limit in response to the moving direction; implementing a third editing toolbar window having an arrangement of a key input display and a plurality of menu functions in response to a touch-removed condition of all touch points constituting the multi-touch event; and subsequent to a second touch, selectively executing one of menu functions on the third editing toolbar window in response to a touch remove event after passing the threshold limit and in response to the passing direction, and processing a touch-removed condition within the threshold limit as a selection of a character key at the corresponding position in the virtual keyboard.

In accordance with some embodiments of the present disclosure, a non-transitory computer readable medium storing a computer program includes computer-executable instructions for causing, when executed in a processor, the processor to perform the aforementioned method for providing an editing operation according to a multi-touch-based text block selection.

### Advantageous Effects

In accordance with the present disclosure, the steps for selecting a text block and editing the selection are simplified by using the multi-touch manipulation to reduce the editing time and thereby provide the user's convenience.

In particular, the present disclosure, when applied to the user environment of the virtual keyboard, conforms the operations for selecting a text block from a text sentence and performing various editing functions to the familiar character input method, and thus facilitates document editing even in smart phones with a small display.

### BRIEF DESCRIPTION OF DRAWINGS

FIG. 1 is a diagram of a configuration of a user terminal that internally performs a method for providing an editing operation responsive to a multi-touch-based text block selection, according to at least one embodiment of the present disclosure.

FIG. 2 is a diagram of an editing cursor moving by a touch manipulation according to the present disclosure.

FIG. 3 is a diagram of a block cursor which is set by a multi-touch operation according to the present disclosure.

FIG. 4 is a view of the opposite block cursor edges moving by a multi-touch operation according to the present disclosure.

FIG. 5 is a diagram of an editing toolbar window displayed for a text block according to the present disclosure.

FIGS. 6 and 7 are diagrams of editing use windows displayed according to the present disclosure.

FIG. 8 is a flowchart of a process for setting or selecting a text block according to the present disclosure.

FIG. 9 is a flowchart of a process for performing editing functions by using the text block according to the present disclosure.

FIGS. 10 and 11 are diagrams conceptually illustrating a process for implementing a text block moving function according to the present disclosure.

FIG. 12 is a diagram of another embodiment of the editing toolbar window according to the present disclosure.

### DETAILED DESCRIPTION

Hereinafter, at least one embodiment of the present disclosure will be described in detail with reference to the accompanying drawings.

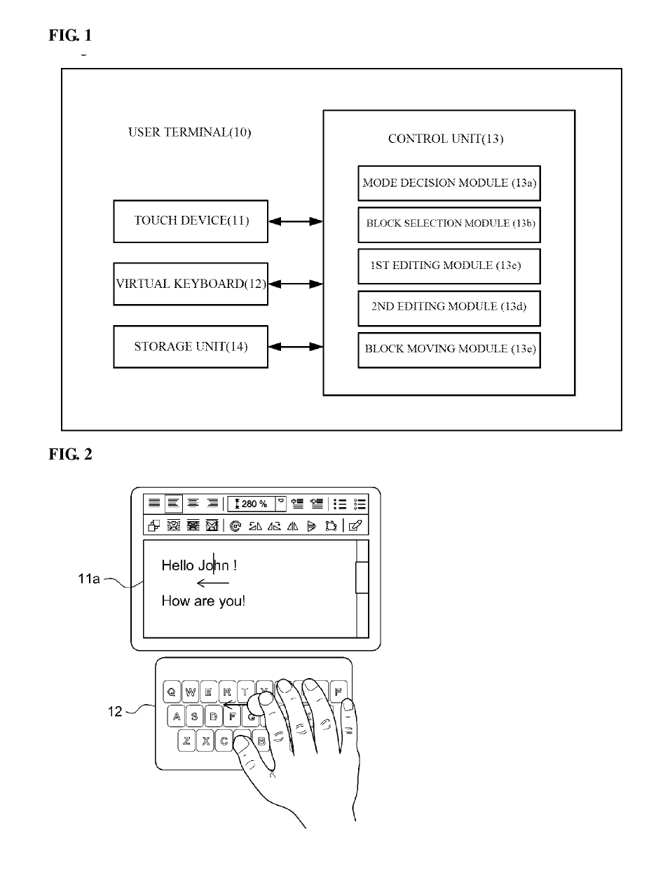

FIG. 1 illustrates a configuration of a user terminal 10 where the inventive method is performed for providing an editing operation responsive to a multi-touch-based text block selection. FIGS. 2-7 are diagrams conceptually illustrating a process for providing an editing operation responsive to a multi-touch-based text block selection, according to at least one embodiment of the present disclosure.

Referring to FIG. 1, the user terminal 10 includes a touch device 11, a virtual keyboard 12, a control unit 13 and a storage unit 14 as the components which are well known in the art of smart phones and smart pads, and therefore further detailed description thereof will be omitted. Depending on the implementation, the virtual keyboard 12 may be virtual keyboard hardware, for example a touch pad printed with the keyboard pattern into a virtual/hardware hybrid keyboard. Depending on the implementation, the virtual keyboard 12 can also be implemented on a trackpad.

The control unit 13 that executes the technique of the text block selection and the editing with the selection according to the present disclosure includes a mode decision module 13a, a block selection module 13b, a first editing module 13c, a second editing module 13d and a block moving module 13e, which are functional modules and are commonly implemented in software. The functions of these components are recognized from the operating process. On the other hand, “module” as used herein are a functional and structural combination of the hardware and software for performing specific technology, and generally refers to a logical unit of program codes and hardware resources, rather than the hardware or software of a particular kind.

FIG. 8 is a flowchart of illustrating a series of steps for selecting a text block according to the present disclosure. The flowchart in FIG. 8 is intended only to show the process is sequentially performed, and depending on implementations, some among these steps can be excluded or other steps not shown in FIG. 8 may be added.

First, the mode decision module 13a displays on the touch device 11, the virtual keyboard 12 with the current input of text sentences in Step S11. For example, when a user applies a touch operation, the mode decision module 13a displays the virtual keyboard 12 as shown in FIG. 2 on the touch device 11. On the other hand, a text editing area 11a and the virtual keyboard 12 may be implemented by assigning their dedicated areas on a single display or they may be implemented by individual terminal devices. In addition, the user's operations from a touch to touch movement are not limited to those performed on the virtual keyboard 12 but include those carried out in the text editing area 11a.

After Step S11, mode decision module 13a switches the operation mode to a cursor moving mode responsive to user request (Step S12). In the cursor moving mode, the editing cursor follows the direction of the user's touch in the text. For example, the switching to the cursor moving mode may be responsive to the touch coordinates shifted beyond a certain range or to the touch state maintained over a certain time. FIG. 2 conceptually illustrates that the user moves a touch (drags) to the left on the virtual keyboard 12 (dragged), and in response, the editing cursor follows suit to move to the left.

The present disclosure clearly shows its advantage when applied to the user environment with the virtual keyboard. The editing operation is streamlined in style to touch-typing on the virtual keyboard 12 to enter characters, during which process the user can select a block from a text sentence and perform the editing functions such as copy, cut and paste more conveniently. Further advantage is the ability to facilitate the editing of a document even in smart phones with a small display.

Before switching to the cursor moving mode in the virtual keyboard user environment, the user does touch-typing on the virtual keyboard 12 to enter characters. In this case, the user's touch-typing input is interpreted as the corresponding virtual key depression to perform the character input associated with it. During the user's touch-typing textual input operations, the mode decision module 13a switches the operation mode to the cursor moving mode in response to an occurrence of at least one of the following events:

(1) a first event on the virtual keyboard where a touch and hold event is concurrent with touch coordinates moving beyond a threshold limit;

(2) a second event on the virtual keyboard where a touch and hold event is present at the same point (within the threshold limit) for more than a threshold time period; and

(3) a third event on the virtual keyboard where there are concurrent multi-touch events, in which one touch point moves beyond the threshold limit.

The following describes a second touch operation in the cursor moving mode, which selects a text block and performs editing functions.

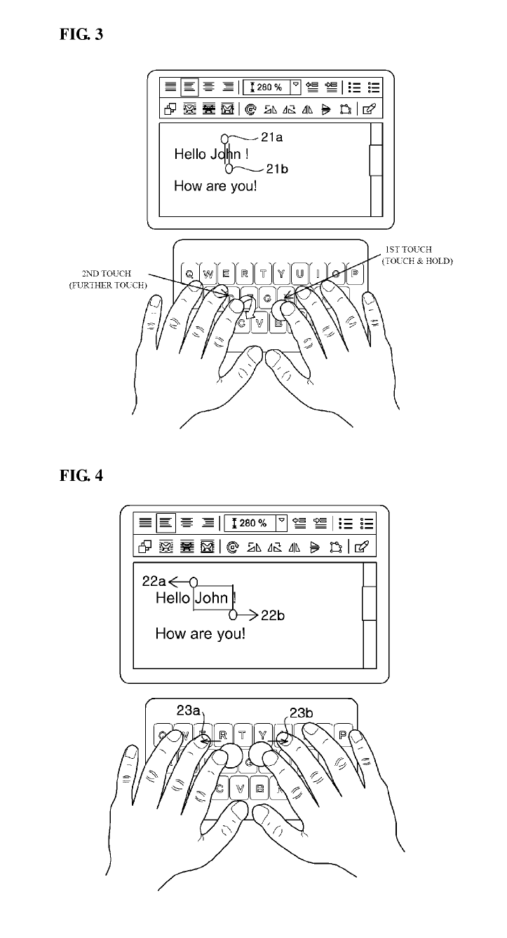

Subsequent to Step S12, on the virtual keyboard 12, a first touch and hold event occurs at first coordinates and a first further touch event occurs at the second coordinates, and then responsive to a touch move starting from respective touch points and shifting beyond a threshold limit, the block selection module 13b performs an implementation of a block cursor represented by the opposite edges 21a, 21b for defining a text block in place of the former cursor on the touch device 11, as shown in FIG. 3 (Step S13).

At this time, the present embodiment may be configured to implement the block cursor 21a, 21b responsive only to the occurrence of threshold excesses of touch movements from the touch points of both the first touch and hold event and the first further touch event, and thereby direct the user to express a definite intention about the text block selection. In addition, the present embodiment may be configured to implement the block cursor 21a, 21b if either one of the touch point of the first touch and hold event and the touch point of the first further touch event moves beyond the threshold limit. In the present disclosure, the block cursor is indicated by two opposite edges 21a, 21b for defining a coverage which in turn defines a text block.

The block cursor 21a, 21b is generated at the point corresponding to the edit cursor, and they may be located at the same location or nearby locations, for example, at the beginning or end of a passage or word. FIG. 3 illustrates when the edit cursor is placed in the middle of “John,” a first further touch event occurs to generate the block cursor 21a, 21b at the same location, although the present embodiment may be reconfigured to generate the block cursor 21a, 21b before and behind “John.”

Referring to FIG. 3, in the cursor moving mode the user maintains the first touch and hold event and entered with the second or further, and thereby implements the block cursor 21a, 21b in the text editing area 11a. Although the drawing simulates using both hands, manipulations with two fingers of one hand are also contemplated. More importantly, the present embodiment concerns correlating the multi-touch operation provided in a touch move mode with the implementation of the block cursor 21a, 21b to define a text block.

Meanwhile, FIGS. 2 and 3 show that the first touch and hold event and the first further touch event occur sequentially and then the touch movements from the respective touch points and beyond the threshold limit start to generate the block cursor 21a, 21b up to the point of entering the text block selection stage. However, these actions need not to be sequential but simultaneous or concurrent to immediately enter into the text block selection stage. The block cursor 21a, 21b may be configured to appear at the occurrence of the aforementioned third event with the concurrent multi-touch events, in which one touch point moves beyond the threshold limit. The different implementations are common in that the block cursor 21a, 21b is generated responsive to multi-touch operations.

The opposite edges 21a, 21b of the block cursor are matchingly assigned to the two touch points (with which the first touch and hold event and the first further touch event make contacts) that make up the multi-touch event. In turn, as shown in FIG. 4, touch movements 23a, 23b of the multi-touch touch points are detected. Responsive to the touch movements 23a, 23b, the block selection module 13b moves (22a, 22b) the opposite edges 21a, 21b of the block cursor, resulting in a fine tuning of the text block by using the opposite edges of the block cursor (Step S14).

The movements 23a, 23b of the two touch points in this manner are correspondingly translated into the movements 22a, 22b of the opposite edges 21a, 21b of the block cursor so as to fine tune the text block selection. The first edge 21a of the block cursor laterally moves (22a) responsive to the lateral movements (23a) of the left touch, and the second edge 21b of the block cursor laterally moves (22b) responsive to the lateral movements (23b) of the right touch. As a result of such movements of the first and second cursor edges 21a, 21b, the text block is finely tuned. FIG. 4 shows the text block selection has been made for “John.”

Meanwhile, although not shown in FIG. 4, the block cursor edges 21a, 21b may also be implemented to intersect each other. In some implementation of the present disclosure, the first edge 21a may be so touch operated as to move to the right and continue to cross the second edge 21b farther to its right side, or the second edge 21b may be moved to the left until it crosses the first edge 21a farther to its left side. In this way, when the block cursors 21a, 21b are implemented to intersect, the text block selection can become more flexible.

The touch move operations (drag operations; 23a, 23b) for moving the respective block cursor edges 21a, 21b may be implemented to seamlessly continue from the initialization operation of the block cursor 21a, 21b in FIG. 3, that is, continue to move the touches held down. Alternatively, the touch move operations may be implemented to stay functional even with the one-hand touch or two-hand touches removed once the block cursor 21a, 21b is established. However, events of notifying the completion of the text block selection are set up depending on the respective implementation methods, which will be described later in Step S15.

Although FIG. 4 depicts the touch move operations 23a, 23b are made on the virtual keyboard 12, they may be made, in some embodiments, to be carried out in an arbitrary area on the touch device 11. The operations may be done with both hands or one hand by two fingers.

Subsequently, upon completion of the text block selection through the above process and detecting the block selection completion event, the first editing module 13c implements an editing toolbar window as shown in FIG. 5 (Step S15). The editing toolbar window is configured to provide editing functions responsive to a text block selection, and it is illustrated as implementing menu functions including, for example, copy, cut, move, paste and clipboard. The present disclosure provides various implementations employing the editing toolbar window, which will be described later referring to FIG. 12.

The block selection completion event is to notify that the text block has undergone its fine tuning and the text block selection is completed. If the scenario is set to have the multi-touch hold from the time of the first touch and hold event and the first further touch event into the implementation of the block cursor 21a, 21b and up to the point of the touch move operations (23a, 23b), then the state in FIG. 5 that the touches are both removed or singularly removed may be set to be the block selection completion event.

However, the present disclosure contemplates various operational scenarios to implement the process of performing the editing operations involving the first editing module 13c to detect the block selection completion event, display the editing toolbar window on the screen, select a specific menu function (copy, cut, move, paste or clipboard) responsive to the user's input of the selection, and carry out the editing function.

A first embodiment may determine the completion of the text block selection in response to the user entering a double-click in the fine tuning of the text block selection. A second embodiment may determine the completion of the text block selection in response to the user touching a “Finish” button provided on the touch display with another finger while fine tuning the text block selection. A third embodiment may determine the completion of the text block selection in response to either one of the first touch and hold event and the first further touch event being touch-removed while fine tuning the text block selection. At this time, if the touch-maintained touch points continue to move to the editing toolbar window where they are touch-removed, it can be determined that the function menu is correspondingly selected.

After Step S15, the first editing module 13c is responsive to the users selection with the editing toolbar window for performing the editing functions on the text block (Step S16).

In the above, description has been provided referring to FIGS. 2 to 5 for the process of selecting a text block from a text sentence and employing the editing function. In these drawings, there is shown an example of selecting a text block in text input software (e.g., MS Word), though the present disclosure is applicable to other software such as a browser involving a text block to be selected on a displayed Web page. At this time, the technical idea of the present disclosure can be realized without the virtual keyboard 12 being displayed.

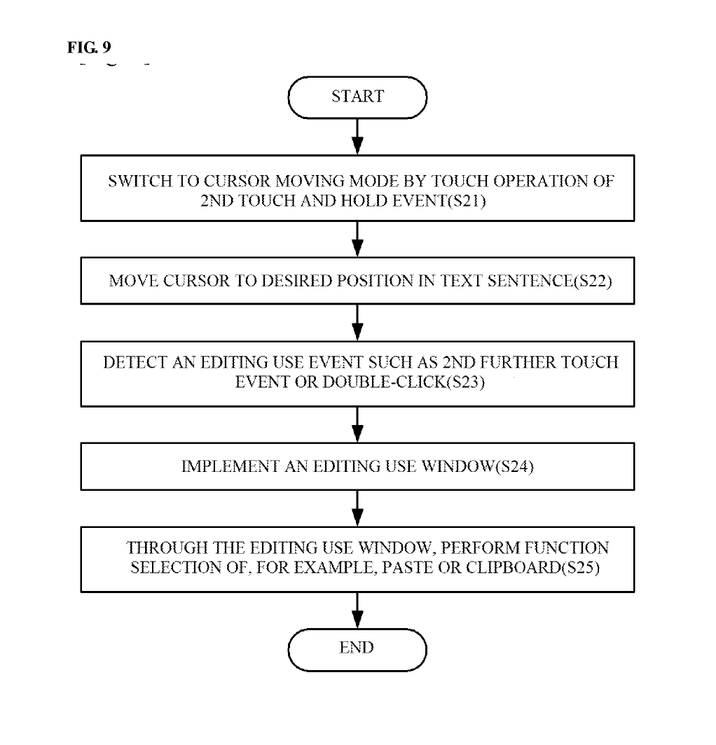

FIG. 9 is a flowchart of a process for performing editing functions by using the selected text block according to the present disclosure. It is assumed that the process of FIG. 9 is preceded by the process of FIG. 8 and the text block selection and copy, cut or such operation.

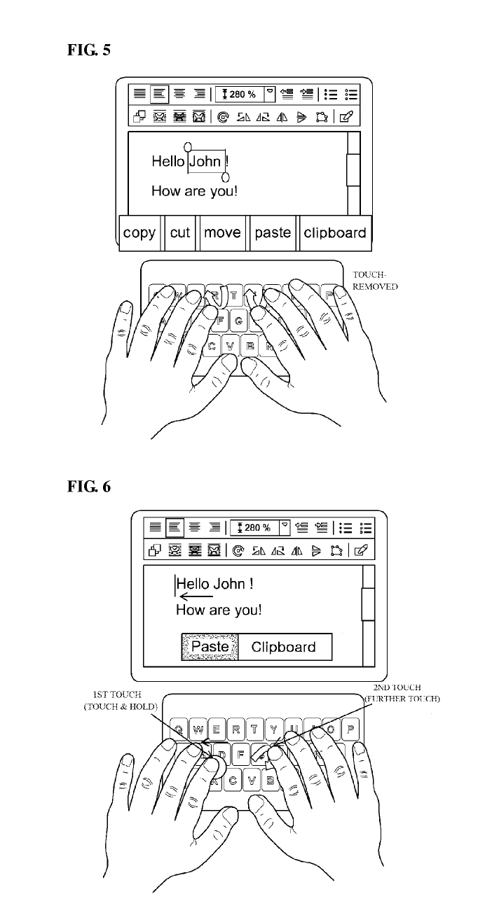

First, after performing the editing function using the editing toolbar window, the mode decision module 13a switches the mode to cursor moving mode in response to a touch operation (Step S21). The touch operation for switching into the cursor moving mode in Step S21 is herein referred to as “second touch and hold event”. FIG. 6 illustrates the user touching the touch device 11 by the left hand and holding a certain period of time to cause the second touch and hold event which in turn causes the mode decision module 13a to make the switching into the cursor moving mode.

After Step S21, responsive to the users touch operation, the mode decision module 13a moves the edit cursor within text sentence to a desired position (Step S22). Step S22 is to move the edit cursor to the point for pasting the previously copied or cut text block. FIG. 6 illustrates the user makes a leftward touch move by the left hand to thereby move the edit cursor to the left.

Thereafter, when detecting a second further touch event of the other coordinates on the touch device 11, the mode decision module 13a interprets the detection as an event for editing use (Step S23). FIG. 6 illustrates the user generating the second further touch event by the right hand, although the illustrated events are not only subject to operation with both hands but to operation with one hand by two fingers.

Responsive to the editing use event in Step S23, the second editing module 13d implements an editing use window for editorial use of the preprocessed text block on the touch device 11 (Step 24). FIG. 6 shows an implementation example of an editing use window having the menu functions of paste and clipboard and highlights the first menu function of paste as a default setting.

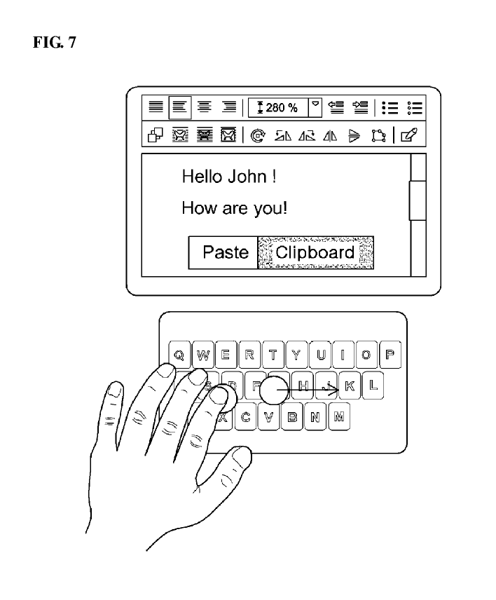

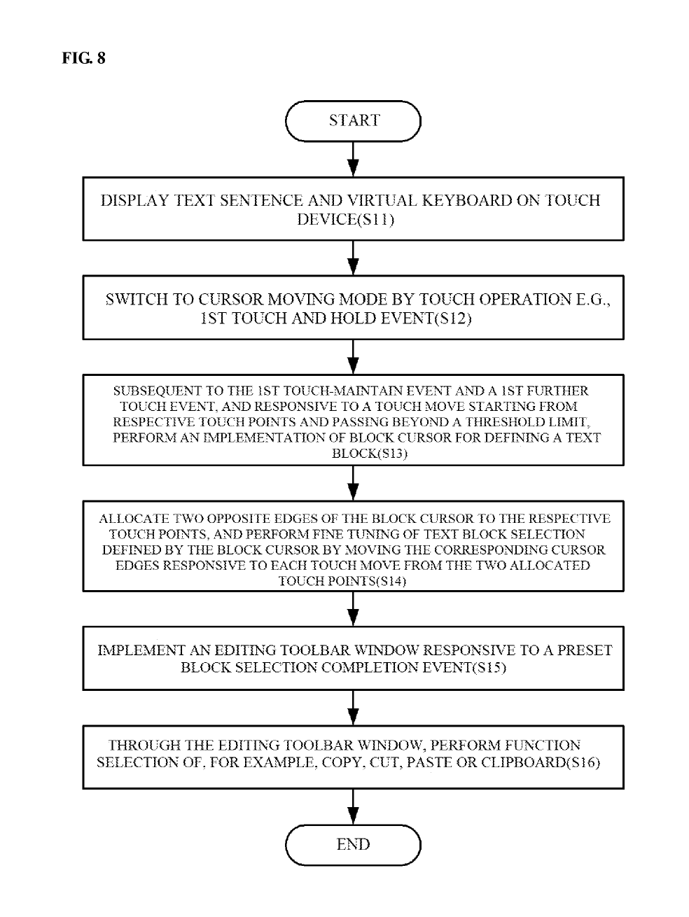

After Step S24, the second editing module 13d, in response to the users touch operation, selects one of the paste and clipboard functions on the editing use window and performs the associated function (Step S25). As shown in FIG. 7, the horizontal touch movement causes a selection between the paste and clipboard functions on the editing use window and the user's removal from the touch has the associated function carried out. For example, FIG. 7 illustrates the right hand had made touch movement to the right to switch highlighting to the clipboard function until the user removes the right hand touch to perform the clipboard function.

The present disclosure contemplates a variety of operational scenarios for the second editing module 13d to perform a detection of the editing use event, display the detection on the editing use window, and perform editing functions according to the user's selected input.

Specifically, a first embodiment may have the user touch-click on the editing use window for selecting a particular function. A second embodiment may have the user start a touch operation with the editing use window displayed to change selection of the menu functions responsive to the touch move operation until the user releases or removes the touch at the then selected menu function as desired, whereby determining the function selection. A third embodiment may have a touch and hold event continue from the second further touch event for displaying the editing use window to move across the editing use window until the user removes the touch and hold event at the then selected menu function as desired, whereby determining the function selection.

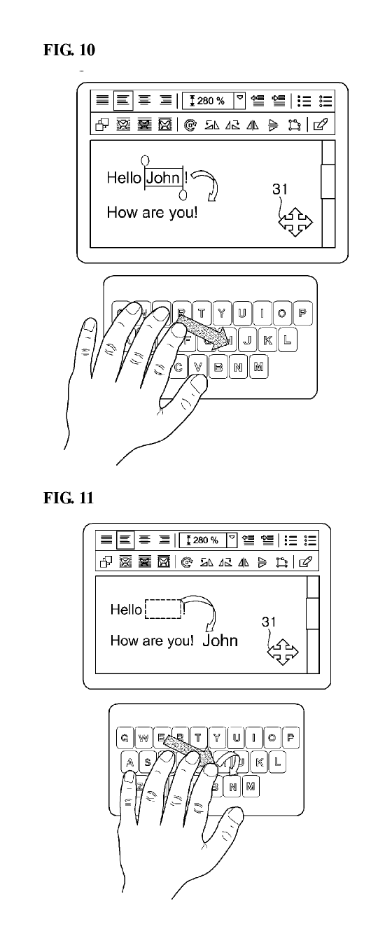

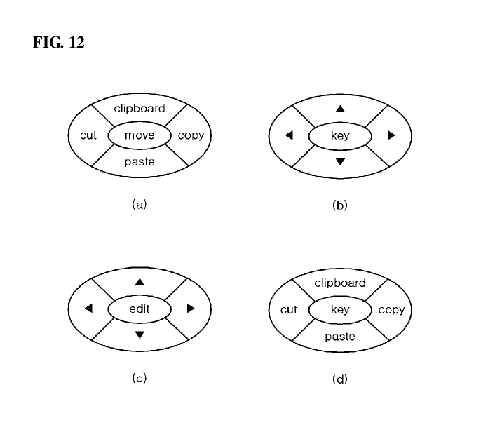

FIGS. 10 and 11 are diagrams conceptually illustrating a process for implementing a text block moving function according to the present disclosure. It is assumed that the text block has been selected through the steps of FIGS. 2 to 4.

With the text block selected, according to the type of touch remove event, i.e., depending on whether the touch removal occurs at a single point or at both the multi-touch points, it is determined whether to display the editing toolbar window of FIG. 5 or to implement the block moving function as in FIGS. 10 and 11. As the editing toolbar window displaying event of FIG. 5 is defined as the block selection completion event, the event as shown in FIG. 10 that causes entering into the block moving mode is herein defined as a block movement start event.

FIG. 5 illustrates that the touch-removed condition of both the multi-touch points is detected as the block selection completion event, whereby displaying the editing toolbar window. Accordingly, FIG. 10 illustrates the multi-touch operation for text block selection and a subsequent singular touch (right hand) removal are detected as the block movement start event to thereby enable the block moving module 13a to implement block moving function.

In addition, when the block moving function is started, it is desirable that the relevant display is performed on the display screen. For example, at the start of the block moving function, the block moving module 13e presents the block moving mode on the display screen at 31 and shades the selected text block (“John”).

With the block movement start event detected, the user's touch operation starts to effect the block movement. First, when the touch movement following the user's touch operation is beyond the preset threshold limit, the process of moving the selected text block is beginning to take place. In other words, the block moving module 13e run the cut processing of text block at its original location, and moves the selected text block (“John”) in a light shadow in the touch-move direction on the screen.

Then, when the touch removal is done, the block moving module 13e places the text block to be moved at the touch remove location. Referring to FIG. 11, the touch move in the block moving mode to the lower right direction and a successive touch removal performed have placed the relocation text block (“John”) next to “How are you!” At this time, depending on implementations, the cut processing of the text block at its original location may take place at the time of touch move of FIG. 10 or at the time of touch removal of FIG. 11.

Meanwhile, even in the block moving mode, if the touch move following the users operation is within the preset threshold limit, the text block movement is preferably not executed, and instead processed as character inputs on the virtual keyboard 12.

FIG. 12 is diagrams showing other exemplary implementations of the editing toolbar window of the present disclosure. First, in case where a text block is selected and then a single touch point is touch-removed, an editing toolbar window as shown in FIG. 12 at (a) may be implemented to pop up. In this state, the user may touch-move the remaining touch point in the vertical and horizontal directions beyond the threshold limit, when the relevant editing menu functions of the editing toolbar window is correspondingly highlighted/selected. Upon selecting a particular editing menu function and touch-removing the remaining touch point, the selected editing menu function is carried out.

At this time, highlighted by default and located in the center is the “move” function, from which the user may not move the touch point any further and touch-remove to pop up an editing toolbar window as shown in FIG. 12 at (b). The movement directions window at FIG. 12(b) is an on-screen display for the purpose of informing of the selected text block in the process of moving operation.

While the movement directions window is displayed at FIG. 12(b), if the user re-touches the touch device and touch-moves in a desired direction, then the selected text block is processed to make the corresponding move. To the contrary, if the range of the touch move is within a preset threshold region, the key (character) is input corresponding to the relevant touch point, which is informed by the display of “key” provided in the center at FIG. 12(b).

On the other hand, a different type of implementation may also be contemplated. For example, if the text block selection is followed by a touch removal of either one touch point, a pop up movement directions window may be implemented as shown at FIG. 12(c) with an edit mark centrally disposed and movement direction marks peripherally arranged. In this state, the user may touch-move the remaining touch point in the vertical and horizontal directions beyond the threshold limit, when the selected text block is processed to make the corresponding move.

Conversely, in case where a text block is selected and then both the touch points are touch-removed, an editing toolbar window as shown at FIG. 12(d) may be implemented to pop up. In this state, if the user re-touches the touch device and touch-moves in a desired direction, then the corresponding function in the editing menu is specified and carried out. As aforementioned with reference to FIG. 12(a), while the editing toolbar window in FIG. 12(d) is displayed, if the range of the re-touch move is within the preset threshold region, the key (character) is input corresponding to the relevant touch point, which is informed by the display of “key” provided centrally of the editing toolbar window.

Further, the aforementioned scenarios may be implemented combined or modified. For example, when the first touch and hold event and the first further touch event are sequentially carried out to establish the multi-touch event as shown in FIGS. 2 and 3, it can be also contemplated that the user has those touch points within the threshold limit and touch-removed.

In this case, when the first touch and hold event is first touch-removed, the character (key) at the first touch and hold event is inputted. Conversely, if the first further touch event is first touch-removed, the editing use window is displayed on screen. These modified configurations can be implemented in the present disclosure.

The present disclosure can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Further, functional programs, codes for carrying out the present disclosure and code segments can be easily inferred by the programmers in the art to which this disclosure belongs.

1. A method for providing an editing operation according to a multi-touch-based text block selection, the method comprising:
in a touch device displaying a text sentence, performing, by a mode detection module (13a), a first identification of at least one multi-touch event on a virtual keyboard of the touch device and a second identification of an event of a touch move representing a movement concurrent with and from a touch at one or more touch points constituting the multi-touch event;
if an identified touch move exceeds a preset threshold limit, performing, by a mode selection module (13b), an implementation of a block cursor (21a, 21b) for defining a text block selected from a displayed text sentence, and an allocation of two of the touch points constituting the multi-touch event to two opposite edges of the block cursor; and
responsive to each touch move (23a, 23b) of two allocated touch points, performing a fine tuning of a text block selection as defined by the block cursor (21a, 21b) by individually moving the opposite edges of the block cursor.

2. The method of claim 1, further comprising:
detecting a touch remove event that the two touch points constituting the multi-touch event are both touch-removed within the preset threshold limit;
processing an earlier touch-removed condition of a first touch point according to the order of touches in the multi-touch event, as a selection of a character key corresponding to the position of the first touch point in the virtual keyboard; and
responsive to an earlier touch-removed condition of a second touch point according to the order of touches in the multi-touch event, implementing an editing use window which includes a function menu of a plurality of functions for an editing use of a preprocessed text block.

3. The method of claim 1, further comprising:
responsive to a preset touch-based block selection completion event, implementing, by a first editing module (13c), a first editing toolbar window having one or more menu functions of copy, cut, move, paste and clipboard for providing an editing function upon completion of the text block selection;
performing, by the first editing module (13c), the editing function with respect to the selected text block in response to a user's first selected input of one of a plurality of the menu functions on the first editing toolbar window;
responsive to a touch manipulation on the touch device, moving an editing cursor to a desired position in a currently displayed text sentence;
responsive to a preset editing use event, implementing, by a second editing module (13d), an editing use window including one or more menu functions of a paste and a clipboard for providing an editing use of a preprocessed text block; and
performing, by the second editing module (13d), the editing use of the preprocessed text block in response to a user's second selected input of one of a plurality of the menu functions on the editing use window.

4. The method of claim 1, further comprising:
responsive to a preset touch-based block movement start event, performing, by a block moving module (13e), a cut process at an original position of the selected text block, with respect to the selected text block when a touch point constituting the preset touch-based block movement start event starts to depart from a threshold limit, and repositioning the selected text block after the cut process in response to a subsequent touch move input.

5. The method of claim 1, further comprising:
responsive to a preset touch-based block movement start event, performing, by a block moving module (13e), a cut process at an original position of the selected text block, with respect to the selected text block after repositioning thereof upon receiving a touch move input.

6. The method of claim 1, further comprising:
upon completion of the fine tuning of the text block selection and responsive to a subsequent touch-removed condition of only one of touch points of the multi-touch event, selecting a movement menu function by default and implementing a second editing toolbar window having an arrangement of a plurality of menu functions;
responsive to a touch-removed condition of the touch-maintained remainder of the touch points of the multi-touch event after moving past a threshold limit, and in response to the moving direction, selectively executing one of menu functions on the second editing toolbar window;
responsive to a touch-removed condition of the touch-maintained remainder of the touch points of the multi-touch event within the threshold limit, implementing a first move display window for displaying a movement of the text block; and
subsequent to a second touch, processing the text block to make a movement corresponding to a touch remove event after passing the threshold limit in response to the moving direction, and processing a touch-removed condition within the threshold limit as a selection of a character key at the corresponding position in the virtual keyboard.

7. The method of claim 1, further comprising:
implementing a second move display window for displaying a movement of the text block upon completion of the fine tuning of the text block selection and responsive to a subsequent touch-removed condition of only one of touch points of the multi-touch event;
processing the text block to make a movement corresponding to a touch remove event of touch-maintained ones of the touch points of the multi-touch event after passing the threshold limit in response to the moving direction;
implementing a third editing toolbar window having an arrangement of a key input display and a plurality of menu functions in response to a touch-removed condition of all touch points constituting the multi-touch event; and
subsequent to a second touch, selectively executing one of menu functions on the third editing toolbar window in response to a touch remove event after passing the threshold limit and in response to the passing direction, and processing a touch-removed condition within the threshold limit as a selection of a character key at the corresponding position in the virtual keyboard.

8. A non-transitory computer readable medium storing a computer program including computer-executable instructions for causing, when executed in a processor, the processor to perform the method of claim 1 for providing an editing operation according to a multi-touch-based text block selection.

9. A non-transitory computer readable medium storing a computer program including computer-executable instructions for causing, when executed in a processor, the processor to perform the method of claim 2 for providing an editing operation according to a multi-touch-based text block selection.

10. A non-transitory computer readable medium storing a computer program including computer-executable instructions for causing, when executed in a processor, the processor to perform the method of claim 3 for providing an editing operation according to a multi-touch-based text block selection.

11. A non-transitory computer readable medium storing a computer program including computer-executable instructions for causing, when executed in a processor, the processor to perform the method of claim 4 for providing an editing operation according to a multi-touch-based text block selection.

12. A non-transitory computer readable medium storing a computer program including computer-executable instructions for causing, when executed in a processor, the processor to perform the method of claim 5 for providing an editing operation according to a multi-touch-based text block selection.

13. A non-transitory computer readable medium storing a computer program including computer-executable instructions for causing, when executed in a processor, the processor to perform the method of claim 6 for providing an editing operation according to a multi-touch-based text block selection.

14. A non-transitory computer readable medium storing a computer program including computer-executable instructions for causing, when executed in a processor, the processor to perform the method of claim 7 for providing an editing operation according to a multi-touch-based text block selection.
